(19) United States
(12) Patent Application Publication
(10) Pub. No.: US 2017/0238595 A1
(43) Pub. Date: Aug. 24, 2017

(54) FEATURES TO IMPROVE 3D PRINT AND ASSEMBLY MACHINES

(71) Applicant: Senake ATURELIYA, London (GB)

(72) Inventor: Senake ATURELIYA, London (GB)

(21) Appl. No.: 15/515,041

(22) PCT Filed: Sep. 11, 2015
(86) PCT No.: PCT/GB2015/000265

§ 371 Date: Mar. 28, 2017

(30) Foreign Application Priority Data
Sep. 29, 2014 (GB) 1417118.5

(51) Int. Cl. A23P 20/20; A47J 43/25; B33Y 30/00; F16C 29/04; F16C 29/00

(52) U.S. Cl. CPC A23P 20/20; F16C 29/045; F16C 29/008; B33Y 30/00; A47J 43/255; A23P 2020/253

(57) ABSTRACT

This invention describes several mechanisms that increase the value and usability of 3D printing and assembly machines.

Additive manufacturing machines which are also commonly known as 3D printers have grown very popular following the vision successfully put forward by the RepRap foundation that because they can replicate themselves we will be able to have a machine at a minimal cost. In the future this could mean that more of us are able to make the shift from consumer to being self sufficient or even become producers. If the majority of people had this home manufacturing technology it would also enable innovators and designers to sell products to a global audience from their desktops. So far the uptake of the technology has so been very limited to enthusiasts and businesses. If interest is not to want then we need to address some of the reasons so that the machines move from the niche to the mass market.

One factor that is limiting the uptake by consumers is that we do not generally consume adequate quantities of non food manufactured product to justify the cost and space that are needed for a 3D printer. The other two most significant factor is that 3D printers are not currently capable of producing products that can compete with the cost and sophistication of mass produced items and that they are relatively very slow.

Some aspects of this invention address the first problem by defining machines with healthy food preparation functionality that users use would want to use every day or which only take up space and time that we do not need.

Other aspects of this invention address the cost and functionality issue by enabling the production of more sophisticated products. This aspect also saves cost and reduces pollution by enabling the reuse of non printable components such as actuators and screens and electronics.

Currently this is limited because the majority of additive and subtractive manufacturing machines are limited to one utilizing one tool at a time. Other more sophisticated machines which have multiple tools still tend to have them mounted on a single positioning system in a given work area. More recently machines have been introduced which have a rotating build surface and manufacturers including ourselves have said that they would introduce multiple heads on radial track that could print with different materials at the same time. One problem with this design is that centrifugal force would limit its speed. Another problem would be that where the printed object or an element within it needed to be printed to one side of the centre of rotation then the strand of material would either need to be stopped and restarted on every rotation or the bed would need to rotate back and forth. In the latter case this would negatively impact any other print head that were operating at the same time.

One aspect of this invention describes a positioning system that is also capable of enabling a multiplicity of tools and pick or pick and place mechanisms to be concurrently and independently moved around a common working volume without the disadvantages of the rotary positioning solution.

According to one embodiment of this invention a multiplicity of carriages are constrained between two mostly or exactly parallel surfaces in such a way that they can only move in a single plane. Each of the carriages is magnetically coupled to a tool or tool carrier positioned either below the lower surface or above the upper one depending on whether the product being printed and assembled is suspended above or sitting below the surfaces.

In a preferred arrangement of this invention the two surfaces would be made from or coated with an electrically conductive material so that they could be electrified to supply the carriages with power ether through their wheels or a separate electrical pick up.

In a preferred arrangement of this invention the two surfaces would incorporate a capacitive positioning system so that the machine would be able to calculate the position and orientation of each carnage.

According to one embodiment of this invention the carriages are mounted on a multiplicity of omni-directional wheels or swiveling castors that run along the two opposing surface between which the carriage is located. When one or more of the wheels are driven the carriage moves and drags the tools or toolheads to which it is coupled with it.

In a preferred arrangement of this invention one surface has three omni-directional wheels running along it. To reduce part count and costs there in just a single omni-directional wheel or castor or ball running invent the other surface.

In another arrangement of this invention one surface has parallel equidistant grooves running along it in one direction and the opposing surface has parallel equidistant grooves running along it in a perpendicular direction. Each carriage has castellated wheels that allow them to roll in one the grooves on one surface but be pushed sideways in the grooves on the opposing surface. Rather than just relying on friction the carriages are now held in position by the wheels interlocking with the grooves allowing for greater forces to be applied to the tool and tool holders.

In another arrangement of this invention the tool or tool carrier is both held onto and driven along a single surface in two perpendicular directions by fluctuating magnetic fields that it generates using electromagnets mounted on the carrier. These interact with fields created by permanent or electromagnets fixed on or in the surface.

In another arrangement of this invention, the tool or tool carrier is both held onto and driven along a single surface in two perpendicular directions by fluctuating magnetic fields generated by electromagnets mounted on or in the surface that interact with fields generated by permanent or electromagnets on the carriage.

In one arrangement of this invention the proximity of the tools and product being constructed would be changed by moving the bed or clamp holding the product which is being produced by the machine closer to or further away.

In another arrangement of this invention the proximity of the tools and product being constructed would be changed by moving the surface holding the tools.

In another arrangement of this invention the proximity of the tools and product being constructed would be changed by changing the individual lengths of the tools or tool holders themselves.

In one arrangement of this invention the component or material holders would hold their own supply of components or material.

In another arrangement of this invention the component or material holders would have a supply of components or material fed to them via a tube or conveyor.

Advantageously to save space both the mechanism holding the carriages and the product being built and the dispensers for tools and materials and components should be able to be folded away when not in use. This would allow products to be printed and assembled in the night by a large machine which would otherwise intrude into required living space that is needed in the day.

According to another aspect of this invention a machine comprises of a multiplicity of material deposition or component pick and place mechanisms that each travel along shafts over a multiplicity of rotating build platforms.

Advantageously to simplify the arrangement of the machine there would be a single rotating build platform or jig and the shafts along which the mechanisms travel would radiate outward from the axis of rotation.

Advantageously to reduce the material and cost of the shafts and supporting framework the shafts and any required supporting members would be arranged like the spokes within a bicycle wheel and tensioned accordingly.

In a preferred arrangement of the machine to minimise the space required by the machine there would be two such wheels located one above the other along a common axis. Carriages supporting the material deposition or component pick and place mechanisms would also incorporate a shaft with toothed pulleys or cogs at either end. These pulleys or cogs would mesh with toothed belts or racks or chains fitted to both the lower and upper guide shafts. As the carriage would then be held in position at both its top and bottom this would minimise any tendency for it to twist when forces are applied to the tool or component holding mechanisms.

The following aspects of this invention apply to 3D printers using the described above as well as machines with Cartesian and rotary material deposition and component placement positioning systems. It is acknowledged that prior art exists for both Cartesian and rotary format printers so novelty is only claimed for the peripheral mechanisms described.

According to one aspect of this invention there are a multiplicity of tools or components or interchangeable material dispensing tanks or reels or loose materials stored so that they could be automatically picked up and released from tool or component or material dispensing holders as required.

In a preferred arrangement of this invention the tool or component or material storage would comprise of pigeonholes or jigs of different sizes located at the edges of the print bed. The tools or components or material holders would be sized to accurately fit the pigeonholes so that they could be pulled out by an actuator on a travelling carriage so that they could be relocated and optionally further processed and placed into a product.

In a preferred arrangement of this invention this storage unit would move vertically so that the required item is aligned with the pick up carriage.

Alternatively if the storage unit is static then it would need to be located sufficiently high above the final built product to ensure that all of the items required for a build could be accessed during it.

Advantageously the same storage mechanisms would receive empty or part used material dispensing tanks or reels for refilling from a larger fixed container of material or components.

According to one aspect of this invention a multiplicity of the pick and place mechanisms would be motorized robots each with a multiplicity of axis.

According to another aspect of this invention the carriages that carry the tools or components or materials would incorporate lower cost non motorised pick and place mechanisms that would be cam driven so that it could reach horizontally in the plane in which it is travelling to pick up a component and re-orientate the component to enable it to be best placed onto or into the product being made.

According to another aspect of this invention there is a tool that dispenses loops of material onto or into a product to add tensile strength to the printed parts.

In a preferred arrangement of the loop dispenser the loops are cut from a tube of material.

Advantageously the tube of material would preferably be formed by winding layers in a circular path so that there is minimal cutting through the strands of the material when cutting off the loops.

According to another aspect of this invention there are a multiplicity of food storage and preparation tools incorporated into the machine,

Advantageously in the case of the machine with material deposition and component placement carriages that are magnetically coupled to the motor driven carriages on the other side of a sheet of material this food preparation equipment would segregate and protect the driven carriages and their components from water and other fluids that might be used to clean this equipment and preparation area.

Advantageously the lower surface would be made out of gorilla glass or another abrasion resistant material so that it did not get significantly scratched or eroded by abrasive cleaning agents.

Food ingredients or components or material storage containers or loose materials would either be pulled or pushed horizontally out of the storage containers or be gravity fed into material deposition or component placement carriages which would transport them to a location for further processing or deposit them into or onto a container.

Advantageously some or all of the means to preprocess ingredients or materials or components such as moving blades or wash jets or graters would either be mounted on the output aperture of the storage container or on the carriage.

Advantageously the means to cut or grate food ingredients would comprise of a rotary disc with quadrants equipped with differently shaped blades and apertures. This would enable a single blade which be spun backward and forwards so that a single blade could be used to carry out different operations without a tool change.

Advantageously the rotary blade would have one quadrant without any apertures that can be used to seal off the aperture between the storage container to enable the build and cutting area to be washed.

This invention will now be illustrated by means of ten figures.

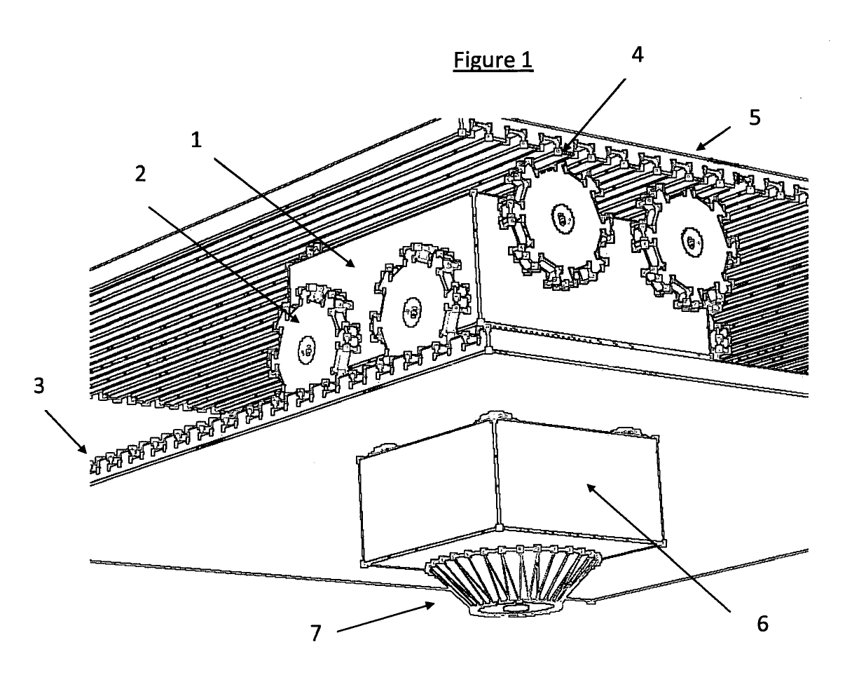

FIG. 1 shows a cartridge supported between two surfaces a multiplicity of free and driven castellated wheels so that it can move in a plane and guide a magnetically coupled tool holder along the underside of the lower surface.

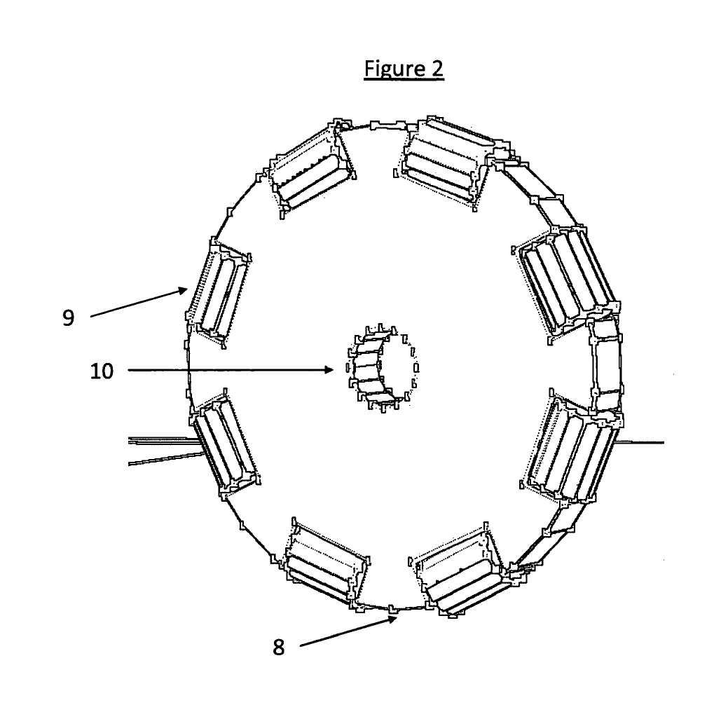

FIG. 2 shows the construction of an omniwheel which is commonly used in the manufacture of robots.

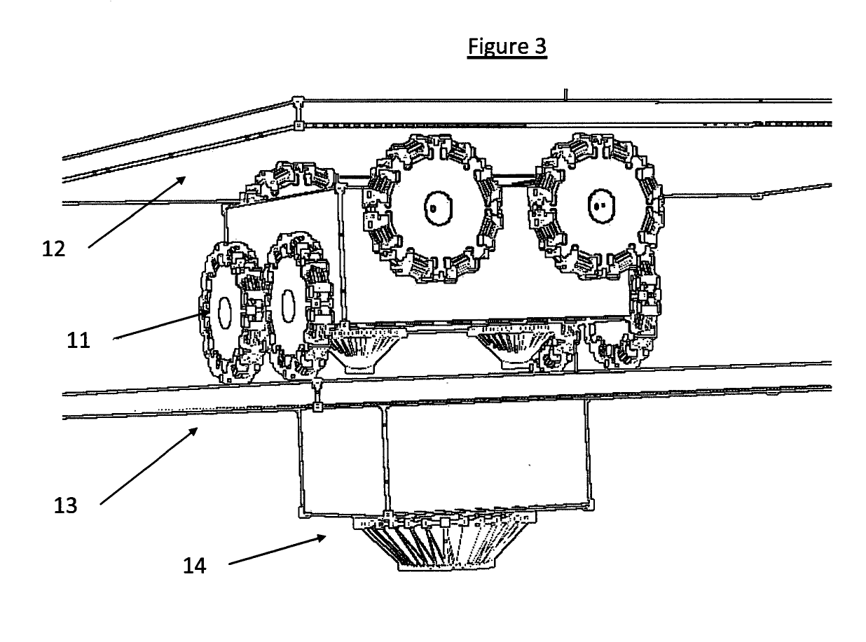

FIG. 3 shows a similar mechanism to that shown FIG. 1 but with the castors replaced by omnidirectional wheels.

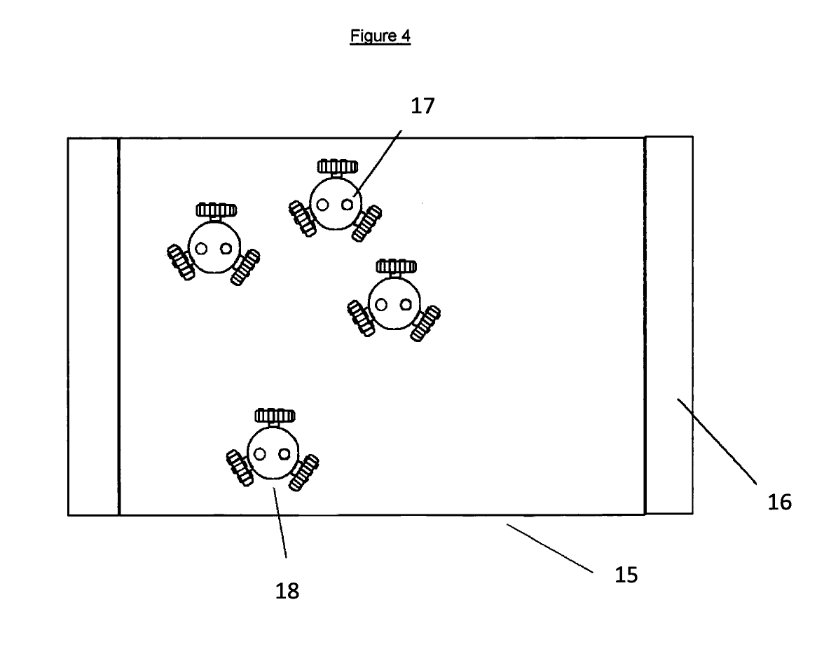

FIG. 4 is the view from above a surface showing a multiplicity of actuator driven carriages that can be independently positioned which are magnetically coupled to carriages below the surface.

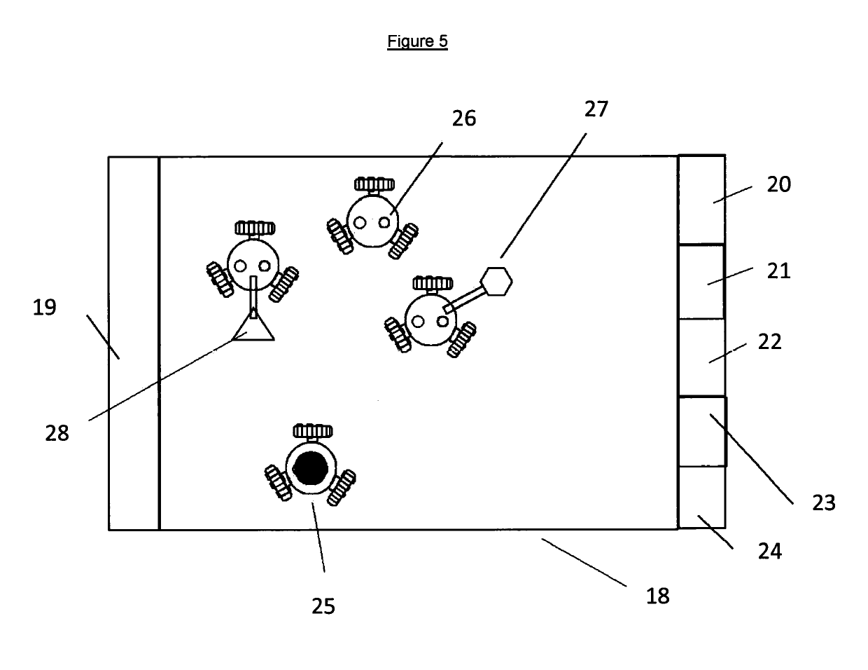

FIG. 5 is the view from below the surface showing a multiplicity of carriages that are magnetically coupled to driven carriages above the surface. The carriages are equipped with tools or material deposition or component positioning mechanisms.

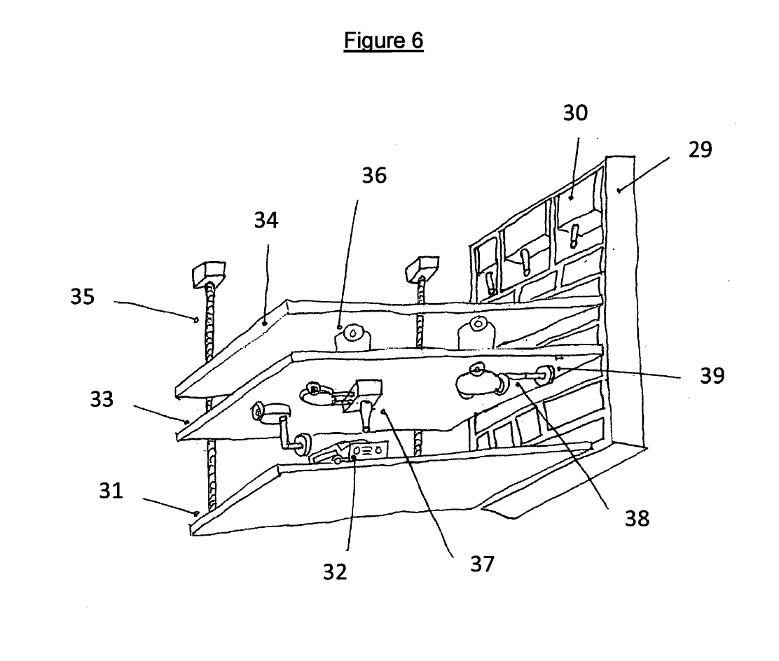

FIG. 6 shows a rotary print mechanism with dual shaft motors mounted on the carriages that move along radial shafts resisting a twisting force applied to it by a tool.

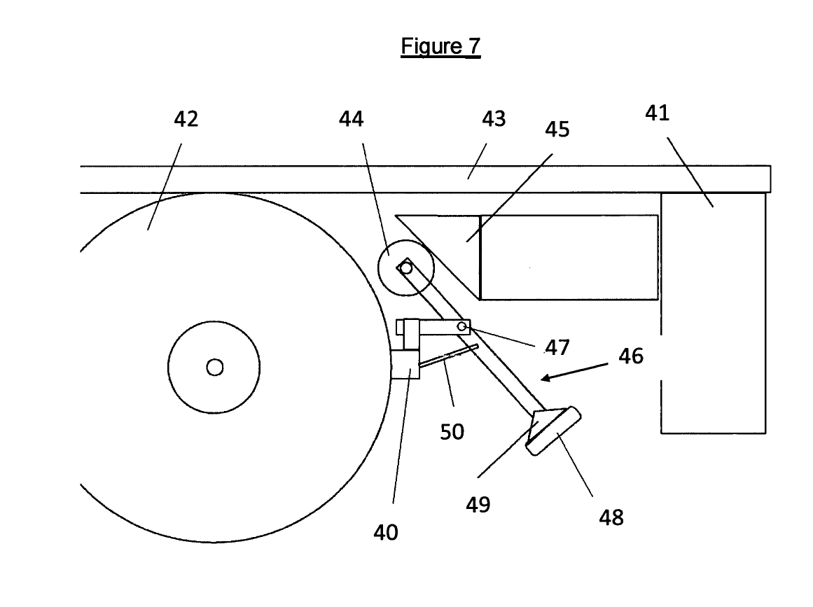

FIG. 7 shows a pick and place unit mounted on a carriage picking a component from a pigeonhole in a storage unit mounted adjacent to a print bed.

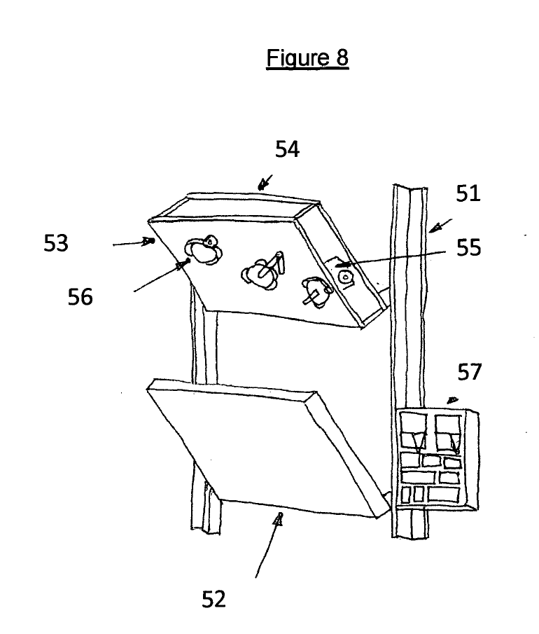

FIG. 8 shows the mechanism holding the carriages and the mechanism holding the product being printed and the storage system for tools and components and materials partly folded away out of the living space.

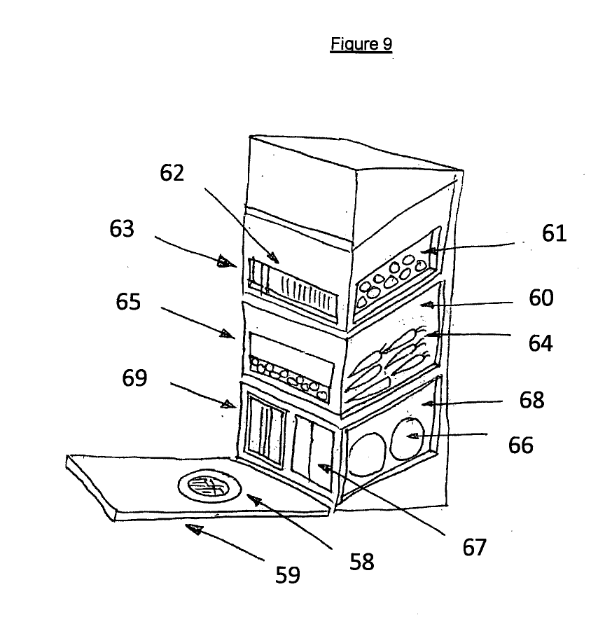

FIG. 9 shows the arrangement of the food storage and preparation and cleaning elements of a machine with a magnetically coupled carriages.

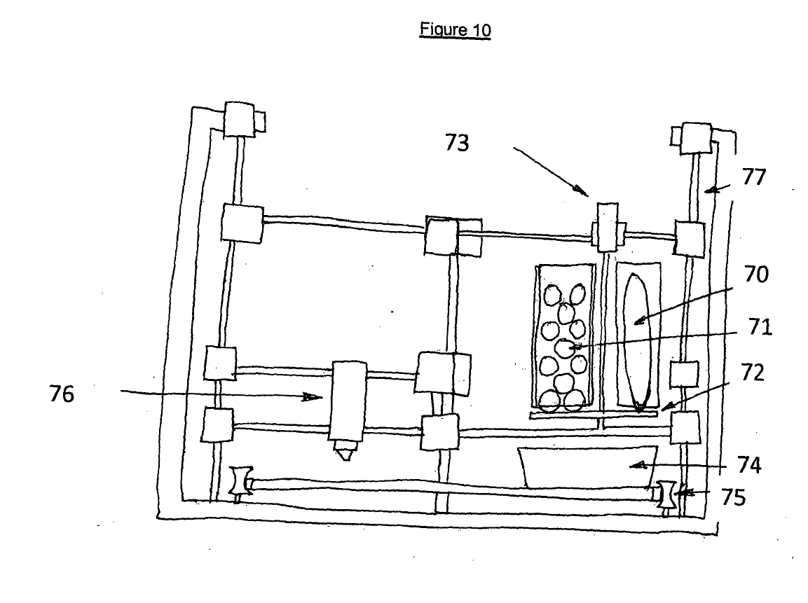

FIG. 10 shows the arrangement of the food storage and preparation and cleaning elements of a machine with a rotary positioning system.

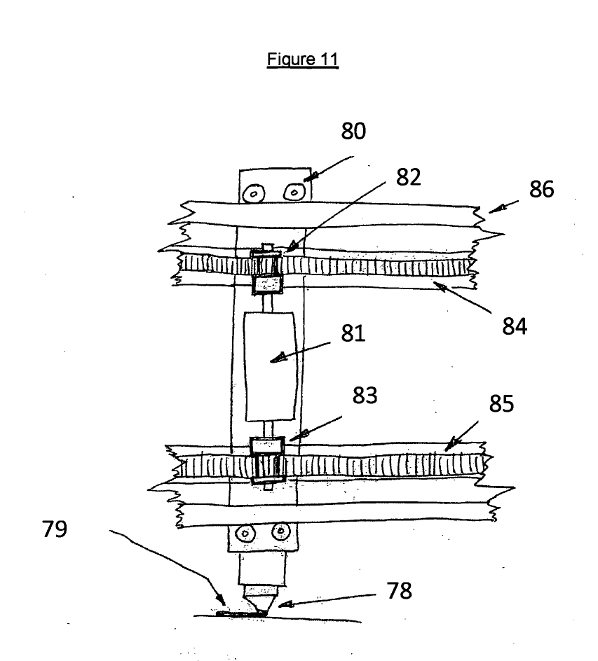

FIG. 11 shows the motor and guide shaft elements of a rotary positioning system.

FIG. 1 depicts a carriage 1 supported by toothed wheels 2 that engage with a grooved surface 3 below it and toothed wheels 4 that engage with a surface 5 which also has grooves which are aligned perpendicular to those on the surface 3. This carriage is magnetically coupled through the surface 3 to a carriage 6 upon which are mounted tools such as the material depositing nozzle 7 shown. When the wheels 2 rotate the carriage is driven in a direction which means that the grooves on the surface 5 slide through the teeth on the wheels 4. Similarly when the wheels 4 are rotated then move the carriage 1 in a direction which means that the grooves on the surface 2 slide through the teeth on the wheels 2. In this way the carriage 1 can be moved precisely without any risk of slippage because the frictional bond between the wheels and surface is broken.

FIG. 2 depicts an omni directional wheel as commonly used by robots comprising of a disc 8 with castellated outer surface into which rollers 9 are mounted to allow the wheel to move sideways. A central hole 10 enables the wheel to be mounted onto an axle. This drawing is only included to define the term onnidirectional wheel.

FIG. 3 depicts a carriage similar to that shown in FIG. 1 with omnidirectional wheels 11 that run against an upper surface 12 and a lower surface 13. This is similarly magnetically coupled to a carriage 14 that runs along the opposite side of the surface 13. Using omnidirectional wheels eliminated the need to have grooved surfaces. If the surfaces 12 and 13 are separated by an optimal distance and the rollers of the omnidirectional wheels 11 and surfaces 12 and 13 are coated with high friction materials then there should be adequate friction to minimise the risk of slippage.

FIG. 4 is a top view showing driven carriages 18 each with three omni directional wheel that run on a surface 15. Each carriage 18 is coupled to a carriage below the surface 15 with two magnets 17 which means that it can control both the position and direction of the carriage to which it is coupled. The surface 15 has cartridges 16 on either side of the surface from which the lower carriages can pick up and drop of tools or components or materials or material containers.

FIG. 5 shows a view of the a surface 18 with cartridges 19 and 20 and 21 and 22 and 23 and 24 that contain a multiplicity of components or tools or materials or material containers. On this surface 18 run carriages 25 that are couples via two magnets 26 each to driven carriages on the other side of the surface 18. The carriages pick up tools or components of materials or material containers 27 using effectors 28.

FIG. 6 is a three dimensional view showing the pigeonhole design of the cartridges 29 that hold the material deposition tools 30 with integral material containers and other components and other tools. The cartridges 29 are mounted next to the surface 31 upon which a product 32 is being printed and assembled. Surfaces 33 and 34 move vertically on lead screws 35 are electrified to supply power to the motorised carriages 36. The magnetically coupled carriages 37 under the surface 31 have electromagnet or suction cup equipped pick and place mechanisms to manipulate the components or tools or materials or material containers 39 as required.

FIG. 7 shows how the pick and place a passive or motorised carriage 40 would operate to pick tools or components or materials or material containers 48 from a cartridge 41. As the carriage 40 mounted on wheels 42 travelling on the surface 43 moved towards the cartridge 41 a cam follower wheel 44 would strike and then roll down the cam 45. This would rotate the linkage 46 anticlockwise about the pivot point 47 to position the end effector 49 into a pick up position to retrieve an item 48 from the cartridge. When the direction of travel was reversed the cam follower wheel 44 would travel back up the cam aided by the spring or elastic band 50 until it hit an end stop at the desired position. The means for attaching the object to the end effector could be an magnetic or suction or gripping. This arrangement would work equally well if reorientate so that the carriage was travelling on top of the surface 43 as opposed to beneath it.

FIG. 8 shows how the components of the magnetically coupled 3D print and assembly machine could be folded away when not in use making it better suited to home printing at night using living space that would be freed up in the day. Brackets 51 would be fixed to a building ideally against a wall. The build surface 52 together with the lower surface 53 and upper surface 54 that hold the magnetically coupled driven carriages 55 and passive carriages 56 would pivot upwards or downwards to move them parallel to the frame 51. The cartridge containing tools and components and materials would ideally pivot horizontally to move so that it was also out of the way. The cartridges 56 could optionally be removed and stored separately. As the cartridges 55 are sandwiched between the surfaces 53 and 54 they would be held in place even if the surfaces were moved into a vertical position.

FIG. 9 shows a system whereby food ingredients 61 in a cartridge 60 may be gravity fed into the side of a print and assembly machine through apertures 62 whilst being processed by a tool 63 that is both a gate and a cutter. In the case of an ingredient such as carrots 64 the tool 65 would either incorporate multiple apertures with sharp edges to grate or slice the ingredient. In the case of a vegetable such as a lettuce 66 the tool 67 would incorporate a single large aperture with sharp edges. The surface 59 would hold a container 58. The carriages that would pack and place the whole or cut food ingredients are not shown as they would have obscured the required detail in this figure.

FIG. 10 shows how a food preparation unit could be incorporated into a 3D printing and assembly machine where there is vertical axis over the build plate with rotary or linear travel. In this case ingredients 70 are placed into tubes 71 that are mounted above a rotating blade 72 that is driven clockwise or anticlockwise by a motor 73. This slices or grates material from the ingredient 70 into the container 74. The build surface can be moved on pulleys 75 to bring a new container into position when one is full. Sauce can also be pumped into the container from a nozzle 76.

FIG. 11 shows a simple and compact mechanism for keeping a 3D print or component pick and place head 80 aligned to a vertical axis where there is a requirement to keep the mechanism narrow. A carriage 80 has a dual shaft motor 81 fixed to it. Pulleys 82 and 83 are mounted onto the upper and lower shafts of the motor. Pulley 82 engages with a rack or belt 84. Pulley 83 engages with a rack or belt 85. A guide 86 is provided along which rollers on the carriage 80 run to support its weight and that of the print head 78. The mechanism helps to stop the twisting of the print head even if there is drag from the deposited material 79.

1. A positioning system comprising a plurality of carriages running along and magnetically coupled to or through a multiplicity of surfaces that are capable of positioning tools or pick and place mechanisms concurrently and independently around a common working volume.

2-17. (canceled)

18. A positioning system as per claim 1 wherein the carriages further comprise a multiplicity of omnidirectional wheels that can be driven to move it in any direction on a first side of one of the surfaces and each of the carriages is magnetically coupled to a tool or carrier positioned on a second side of the one of the surfaces.

19. A positioning system as per claim 1 wherein the carriages are constrained between two substantially parallel ones of the surfaces in such a way that they can only move in a single plane and each of the carriages is magnetically coupled to a tool or carrier positioned below a lower one of the substantially parallel ones of the surfaces and the product is printed and assembled below the lower one of the substantially parallel ones of the surfaces.

20. A positioning system as per claim 1 wherein the carriages are constrained between two substantially parallel ones of the surfaces in such a way that they can only move in a single plane and each of the carriages is magnetically coupled to a tool or carrier positioned above an upper one of the substantially parallel ones of the surfaces and the product is suspended and printed and assembled above the upper one of the substantially parallel ones of the surfaces.

21. A positioning system as per claim 1 wherein two of the surfaces are made from or coated with an electrically conductive material so that they can be electrified to supply the carriages with power either through their wheels or a separate electrical pick up.

22. A positioning system as per claim 1 wherein two of the surfaces incorporate a capacitive positioning system so that the machine into which it is built can calculate the position and orientation of each of the carriages.

23. A positioning system as per claim 1 wherein the carriages are mounted on a multiplicity of omni-directional wheels or swiveling castors that run along two opposing ones of the surfaces between which one or more of the carriages are located so that when one or more of the omni-directional wheels are driven the one or more of the carriages moves and drags one or more tools or toolheads to which the one or more of the carriages are coupled.

24. (canceled)

25. A positioning system as per claim 1 wherein one of the surfaces has a first set of parallel equidistant grooves running along it in one direction and an opposing one of the surfaces has a second set of parallel equidistant grooves running along it in a substantially non-parallel direction and each of the carriages has a multiplicity of castellated wheels that allow them to engage with and roll across the first set of parallel equidistant grooves on the one of the surfaces but be pushed sideways along the second set of parallel equidistant grooves in the opposing one of the surfaces.

26-32. (canceled)

33. A mechanism that holds a product being built which can be positioned in a substantially horizontal plane when it is in use but can then be moved into a largely vertical plane for storage when it is not in use.

34. A mechanism as per claim 33 that holds dispensers for tools and materials and components in a position at an edge of a build area when a machine is in use but then moves them into another position when the machine is not in use.

35. A mechanism as per claim 33 that is mounted to a wall and configured to hold a positioning system in the substantially horizontal plane when it is use but then move it into the largely vertical plane against the wall for storage when it is not in use.

36-43. (canceled)

44. A tool that dispenses loops of material onto or into a product being built on a 3D printer to add tensile strength to one or more printed parts.

45. A tool as per claim 44 comprising means for cutting the loops from a tube of a material.

46. A tool as per claim 45 wherein the tube of the material is formed by winding layers in a circular path to facilitate minimal cutting through strands of the material when cutting the loops from the tube of the material.

47. An apparatus comprising a multiplicity of food storage containers and food preparation tools and material deposition and component placement carriages that are magnetically coupled to a plurality of motor driven carriages on the other a side of a sheet of material so that the food storage containers and food preparation tools are segregated to protect the motor driven carriages and their components from water and other fluids used to clean the food storage containers and food preparation tools.

48-52. (canceled)

53. An apparatus as per claim 47 further comprising:
means to cut or grate food ingredients comprising a rotary disc with quadrants equipped with differently shaped blades and apertures so that it can be spun backward and forwards to carry out different operations without a tool change; and
one or moving blades, wash jets, or graters mounted on an output aperture of one or more of the food storage containers or one or more of the component placement carriages or motor driven carriages.

54. An apparatus as per claim 53 wherein one of the quadrants of the rotary disc does not comprise any apertures so that the disc can be rotated into a position where one or more of the food storage containers is sealed off from a build and cutting area whilst it is being washed.
